(19) United States
(12) Patent Application Publication
(10) Pub. No.: US 2026/0275458 A1
(43) Pub. Date: Sep. 17, 2026

(54) PRINTABLE GAMMA PRIME SUPERALLOYS

(71) Applicant: OERLIKON METCO (US) INC., Westbury, NY (US)

(72) Inventors: Jonathon BRACCI, Escondido, CA (US); Justin CHENEY, Encinitas, CA (US); Kevin KAUFMANN, Oceanside, CA (US)

(73) Assignee: OERLIKON METCO (US) INC., Westbury, NY (US)

(21) Appl. No.: 19/469,127

(22) PCT Filed: Apr. 10, 2024
(86) PCT No.: PCT/US2024/023805

§ 371 Date: Sep. 25, 2025

Related U.S. Application Data
(60) Provisional application No. 63/461,667, filed on Apr. 25, 2023.

(51) Int. Cl. C22C 19/05; B33Y 70/00

(52) U.S. Cl. CPC C22C 19/055; B33Y 70/00

(57) ABSTRACT

A nickel-based alloy composition for additive manufacturing and an additive manufacturing component made from the nickel-based alloy, which includes: 36-89 wt. % nickel; 4-9 wt. % aluminum; 6-14 wt. % cobalt; 4-26 wt. % chromium; 2-5 wt. % tantalum; and 3-13 wt. % tungsten. The nickel-based alloy composition provides an additive manufacturing component having a cracking density of less than 4.0 cracks/mm².

### CROSS-REFERENCE TO RELATED APPLICATION

This application claims the benefit of U.S. Provisional Application No. 63/461,667 filed Apr. 25, 2023, the disclosure of which is expressly incorporated by reference herein in its entirety.

### BACKGROUND

### 1. Field of the Invention

Embodiments are directed to Ni-based alloys used for additive manufacturing (AM) of net-shape or near-net-shape components for, but not limited to, aerospace, power generation, automotive, or general industrial applications.

### 2. Discussion of Background Information

Gamma prime strengthened superalloys are an important material used in the fabrication of components exposed to high temperatures in gas turbine engines. They generally exhibit high mechanical strength, creep resistance, corrosion resistance and oxidation resistance at high temperatures. Gamma prime precipitates are key in achieving these unique properties.

Historically, superalloy design has centered around conventional manufacturing processes such as casting or forging. However, with advancements in AM capabilities, there is increasing interest in using AM to produce gamma prime strengthened superalloy components. In this regard, AM offers advantages such as increased component design freedom and lower material waste as compared to conventional manufacturing processes.

A primary requirement for successful manufacturability of superalloys via AM is the ability to print crack free components. It has been observed that cracking increases with an increase of gamma prime phase fraction, which makes successful AM processing more difficult for high gamma prime superalloys.

Cracking or any defects in the AM component significantly reduces the mechanical properties and performance of the component, such that the advantages gained from AM over conventional manufacturing techniques are lost if these AM components cannot achieve the required performance.

In the known prior art, special manufacturing techniques are provided for gamma prime superalloys having large compositional ranges, but these compositional ranges do not teach the technology disclosed here in that they contain both cracking and non-cracking superalloy compositions when applied via an AM manufacturing process. In fact, the vast majority of potential alloys within these broad compositional ranges will crack if applied via the additive manufacturing process. By way of example, U.S. Pat. No. 4,226,644 describes manufacturing a superalloy part via a compacting particulate matter technique considered relevant to a broad compositional range. However, a majority of alloys within the disclosed compositional ranges will crack if processed via additive manufacturing. Further, US 2020/0010930 A1 describes manufacturing a superalloy part by a hot plastic working technique considered relevant to a broad compositional range. Again, a majority of alloys within the compositional range will crack if processed via additive manufacturing.

While a gamma prime strengthened nickel-based superalloy AM is known from, e.g., EP 2886225 B1, EP 2949768 B1 U.S. Pat. No. 10,941,466 B2, U.S. Pat. No. 10,752,978 B2, US 2021/0355564 A1, US 2020/0172998 A1, US 2020/0149145 A1, these alloys contain components in amounts outside of the ranges described in the disclosed embodiments and likewise result in unacceptable cracking in the AM part. Moreover, while other gamma prime strengthened nickel-based superalloys are known, e.g., from U.S. Pat. Nos. 5,069,873, 9,902,021B2, 10,358,701B2, 11,459,640B2, US20190055627A1, WO2018157228A1, these alloys likewise contain components in amounts outside of the ranges described in the disclosed embodiments, resulting in unacceptable cracking in the AM part.

### SUMMARY

Embodiments are directed to improving manufacturability of high gamma prime superalloys by reducing crack susceptibility in AM processing.

Embodiments are directed to a nickel-based alloy composition for additive manufacturing that includes: 4-9 wt. % aluminum; 6-14 wt. % cobalt; 4-26 wt. % chromium; 2-5 wt. % tantalum; 3-13 wt. % tungsten; and a balance of nickel.

According to embodiments, the nickel-based alloy composition can further include at least one of: up to 8 wt. % molybdenum; up to 1 wt. % titanium; and up to 4 wt. % niobium.

In other embodiments, the composition of aluminum may be 4.5-7.7 wt. %, the composition of cobalt can be 7.7-12.9 wt. %, the composition of chromium can be 5-23 wt. %, the composition of tantalum may be 2.5-4.8 wt. %, and the composition of tungsten can be 3.3-11 wt. %. The nickel-based alloy composition may further include at least one of: up to 7.0 wt. % molybdenum; up to 0.9 wt. % titanium; and up to 2.8 wt. % niobium. In other embodiments, the composition of aluminum can be 5-7 wt. %, the composition of cobalt can be 8-12 wt. %, the composition of chromium can be 5-23 wt. %, the composition of tantalum can be 3-4 wt. %, and the composition of tungsten can be 4-11 wt. %. The nickel-based alloy composition may further include at least one of: up to 7 wt. % molybdenum; up to 1 wt. % titanium; and up to 3 wt. % niobium.

In still other embodiments, an additive manufacturing component can include the above-identified nickel-based alloy composition. The component can include at least one of: a hot cracking index less than 2.0; a Scheil mushy zone of less than 250K; an equilibrium mushy zone less than 100K; a gamma prime phase fraction at 1200K between 40 and 67 mol %; a gamma prime formation temperature less than 1500K; a topologically close-packed (TCP) formation temperature is between 900K and 1650K; a crack density of less than 1.50 mm/mm²; or a hardness between 350 HV_{0.3} and 560 HV_{0.3}.

In accordance with embodiments, the nickel-based alloy composition can more particularly include: Al: 3.9-7.2 wt. %; Co: 6.4-12.0 wt. %; Cr: 14.0-26.0 wt. %; Mo: 0.4-0.7 wt. %; Ta: 2.2-4.0 wt. %; Ti: 0.5-0.9 wt. %; W: 6.7-12.4 wt. %; and Ni: balance. Further, the composition of aluminum may be 4.7-6.3 wt. %; the composition of cobalt may be 7.8-10.6 wt. %; the composition of chromium may be 17.0-23.0 wt. %; the composition of molybdenum may be 0.4-0.6 wt. %; the composition of tantalum may be 2.6-3.6 wt. %; the composition of titanium may be 0.6-0.8 wt. %; and the composition of tungsten may be 8.1-10.9 wt. %. An additive manufacturing component can include the above nickel-based alloy composition and have a crack density of 0.09 mm/mm². Moreover, the component may exhibit a hot cracking index of 0.58.

According to other embodiments, the nickel-based alloy composition can more particularly include: Al: 3.9-7.2 wt. %; Co: 6.4-12.0 wt. %; Cr: 5.7-10.7 wt. %; Mo: 4.2-7.8 wt. %; Ta: 2.2-4.0 wt. %; Ti: 0.5-0.9 wt. %; W: 6.7-12.4 wt. %; and Ni: balance. Further, the composition of can be is 4.7-6.3 wt. %; the composition of cobalt can be 7.8-10.6 wt. %; the composition of chromium can be 7.0-9.4 wt. %; the composition of molybdenum can be 5.1-6.9 wt. %; the composition of tantalum can be 2.6-3.6 wt. %; the composition of titanium can be 0.6-0.8 wt. %; and the composition of tungsten can be 8.1-10.9 wt. %. An additive manufacturing component can include the above nickel-based alloy composition and have a crack density of 0.12 mm/mm². Moreover, the component can exhibit a hot cracking index of 0.50.

In accordance with other embodiments, the nickel-based alloy composition may particularly include: Al: 3.9-7.2 wt. %; Co: 6.4-12.0 wt. %; Cr: 5.7-10.7 wt. %; Mo: 0.4-0.7 wt. %; Nb: 1.5-2.9 wt. %; Ta: 2.2-4.0 wt. %; W: 2.8-5.2 wt. %; and Ni: balance. Further, the composition of aluminum may be 4.7-6.3 wt. %; the composition of cobalt may be 7.8-10.6 wt. %; the composition of chromium may be 7.0-9.4 wt. %; the composition of molybdenum may be 0.4-0.6 wt. %; the composition of niobium may be 1.9-2.5 wt. %, the composition of tantalum may be 2.6-3.6 wt. %; the composition of tungsten may be 3.4-4.6 wt. %. An additive manufacturing component can include the above nickel-based alloy composition and have a crack density of 1.31 mm/mm². Moreover, the component may exhibit a hot cracking index of 1.76.

In still other embodiments, the nickel-based alloy composition can include: Al: 3.9-7.2 wt. %; Co: 6.4-12.0 wt. %; Cr: 7.1-13.3 wt. %; Mo: 0.4-0.7 wt. %; Ta: 2.2-4.0 wt. %; Ti: 0.5-0.9 wt. %; W: 5.3-9.8 wt. %; and Ni: balance. Further, the composition of aluminum can be 4.7-6.3 wt. %; the composition of cobalt can be 7.8-10.6 wt. %; the composition of chromium can be 8.7-11.7 wt. %; the composition of molybdenum can be 0.4-0.6 wt. %; the composition of tantalum can be 2.6-3.6 wt. %; the composition of titanium can be 0.6-0.8 wt. %; and the composition of tungsten can be 6.4-8.6 wt. %. An additive manufacturing component can include the above nickel-based alloy composition and have a crack density of 1.37 mm/mm². Further, the component can exhibit a hot cracking index of 1.24.

According to still other embodiments, the nickel-based alloy composition may include: Al: 4.6-8.5 wt. %; Co: 7.7-14.3 wt. %; Cr: 4.2-7.8 wt. %; Ta: 2.2-4.0 wt. %; W: 5.6-10.4 wt. %; and Ni: balance. Moreover, the composition of aluminum may be 5.5-7.5 wt. %; the composition of cobalt may be 9.4-12.7 wt. %; the composition of chromium may be 5.1-6.9 wt. %; the composition of tantalum may be 2.6-3.6 wt. %; the composition of tungsten may be 6.8-9.2 wt. %. An additive manufacturing component may include the above nickel-based alloy composition and have a crack density of 1.44 mm/mm². The component may exhibit a hot cracking index of 0.95.

In accordance with still yet other embodiments, the nickel-based alloy the composition can include: Al: 4.6-8.5 wt. %; Co: 7.0-13.0 wt. %; Cr: 5.6-10.4 wt. %; Ta: 2.8-5.2 wt. %; W: 4.2-7.8 wt. %; and Ni: balance. Further, the composition of aluminum can be 5.5-7.5 wt. %; the composition of cobalt can be 8.5-11.5 wt. %; the composition of chromium can be 6.8-9.2 wt. %; the composition of tantalum can be 3.4-4.6 wt. %; and the composition of tungsten can be 5.1-6.9 wt. %. An additive manufacturing component can include the above nickel-based alloy composition and have a crack density of 1.46 mm/mm². Moreover, the component can exhibit a hot cracking index of 0.88.

Embodiments are directed to an additive manufacturing component that includes a nickel-based alloy composition; and has a hot cracking index of less than 2.0, a Scheil mushy zone of less than 250K, an Equilibrium mushy zone less than 100K, a gamma prime phase fraction at 1200K between 40 and 65 mol %, a gamma prime formation temperature less than 1500K, and a TCP formation temperature between 900K and 1600K.

Embodiments are directed to an additive manufacturing component that includes a nickel-based alloy composition; and has a crack density of less than 1.50 mm/mm² and a hardness between 350 HV_{0.3} and 560.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 graphically depicts the Scheil-Gulliver model based on the solidification behavior of the alloy for calculating the hot cracking index (HCI) for an embodiment;

FIG. 2 graphically depicts the Scheil-Gulliver model for determining an alloys mushy zone for an embodiment;

FIG. 3 graphically depicts the equilibrium calculation specifically highlighting the gamma prime fraction and Equilibrium mushy zone for an exemplary embodiment;

FIG. 4 graphically depicts the equilibrium calculation specifically highlighting the formation temperature of gamma prime and the first TCP phase for an exemplary embodiment; and

FIG. 5 shows cracking in a printed microstructure of a known gamma prime superalloy.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

As used herein, the singular forms “a,” “an,” and “the” include the plural reference unless the context clearly dictates otherwise. For example, reference to “a powder material” would also mean that mixtures of one or more powder materials can be present unless specifically excluded. As used herein, the indefinite article “a” indicates one as well as more than one and does not necessarily limit its referent noun to the singular.

Except where otherwise indicated, all numbers expressing quantities used in the specification and claims are to be understood as being modified in all examples by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range (unless otherwise explicitly indicated). For example, if a range is from about 1 to about 40, it is deemed to include, for example, 1, 7, 23.7, 34, 36.1, 40, or any other value or range within the range.

As used herein, the terms “about” and “approximately” indicate that the amount or value in question may be the specific value designated or some other value in its neighborhood. Generally, the terms “about” and “approximately” denoting a certain value is intended to denote a range within +5% of the value. As one example, the phrase “about 100” denotes a range of 100±5, i.e., the range from 95 to 105. Generally, when the terms “about” and “approximately” are used, it can be expected that similar results or effects according to the disclosure can be obtained within a range of +5% of the indicated value.

The term “at least partially” is intended to denote that the following property is fulfilled to a certain extent (such as 25% or 50%) or completely.

The terms “substantially” and “essentially” are used to denote that the following feature, property or parameter is either completely (entirely) realized or satisfied or to a major degree (such as 90%, 95%, or 99%) that does not adversely affect the intended result.

The term “comprising” as used herein is intended to be non-exclusive and open-ended. Thus, for example a composition comprising oxide A may include other oxides besides A. However, the term “comprising” also covers the more restrictive meanings of “consisting essentially of” and “consisting of”, so that for example “a composition comprising oxide A” may also (essentially) consist of the oxide A.

In the present disclosure, unless otherwise noted, all weight percentages pertaining to an element/component of a composition/material/layer are based on the total weight of the composition/material/layer including any unavoidable impurities that may be present.

An alloy composition according to embodiments provides a high gamma prime superalloy with improved manufacturability by reducing the crack susceptibility of the alloy in additive manufacturing (AM) processing. This alloy composition includes nickel as a majority element and can further include aluminum, cobalt, chromium, molybdenum, niobium, tantalum, titanium, and tungsten. In a preferred embodiment, the alloy composition can include about 4-9 wt. % aluminum, 6-14 wt. % cobalt, 4-26 wt. % chromium, 2-5 wt. % tantalum, 3-13 wt. % tungsten, and a balance of nickel. Moreover, this alloy composition may (optionally) include at least one of up to 8 wt. % molybdenum, up to 4 wt. % niobium and/or up to 1 wt. % titanium. Further, when the alloy composition includes niobium, it may be advantageous to include niobium only up to 1.0 wt. % and preferably only up to 0.5 wt. %.

In a further preferred embodiment, the alloy composition may include about 5-7 wt. % aluminum, 8-12 wt. % cobalt, 5-23 wt. % chromium, 3-4 wt. % tantalum, and 4-11 wt. % tungsten. Moreover, this preferred embodiment of the alloy composition may (optionally) include at least one of up to 7 wt. % molybdenum, up to 3 wt. % niobium and/or up to 1 wt. % titanium. Moreover, when the alloy composition includes niobium, it may be advantageous to include niobium only up to 1.0 wt. % and preferably only up to 0.5 wt. %.

### EXAMPLES

Example 1 (X2): the alloy composition includes:
Al: 3.9-7.2 wt. % and preferably 4.7-6.3 wt. %;
Co: 6.4-12.0 wt. % and preferably 7.8-10.6 wt. %,
Cr: 14.0-26.0 wt. % and preferably 17.0-23.0 wt. %,
Mo: 0.4-0.7 wt. % and preferably 0.4-0.6 wt. %,
Ta: 2.2-4.0 wt. % and preferably 2.6-3.6 wt. %,
Ti: 0.5-0.9 wt. %; and preferably 0.6-0.8 wt. %
W: 6.7-12.4 wt. % preferably 8.1-10.9 wt. %;
Ni: balance.

Example 2 (X3):
Al: 3.9-7.2 wt. % and preferably 4.7-6.3 wt. %;
Co: 6.4-12.0 wt. % and preferably 7.8-10.6 wt. %;
Cr: 5.7-10.7 wt. % and preferably 7.0-9.4 wt. %;
Mo: 4.2-7.8 wt. % and preferably 5.1-6.9 wt. %;
Ta: 2.2-4.0 wt. % and preferably 2.6-3.6 wt. %;
Ti: 0.5-0.9 wt. % and preferably 0.6-0.8 wt. %;
W: 6.7-12.4 wt. % and preferably 8.1-10.9 wt. %; and
Ni: balance.

Example 3 (X4):
Al: 3.9-7.2 wt. % and preferably 4.7-6.3 wt. %;
Co: 6.4-12.0 wt. % and preferably 7.8-10.6 wt. %;
Cr: 5.7-10.7 wt. % and preferably 7.0-9.4 wt. %;
Mo: 0.4-0.7 wt. % and preferably 0.4-0.6 wt. %;
Nb: 1.5-2.9 wt. % and preferably 1.9-2.5 wt. %;
Ta: 2.2-4.0 wt. % and preferably 2.6-3.6 wt. %;
W: 2.8-5.2 wt. % and preferably 3.4-4.6 wt. %; and
Ni: balance.

Example 4 (X5):
Al: 3.9-7.2 wt. % and preferably 4.7-6.3 wt. %;
Co: 6.4-12.0 wt. % and preferably 7.8-10.6 wt. %;
Cr: 7.1-13.3 wt. % and preferably 8.7-11.7 wt. %;
Mo: 0.4-0.7 wt. % and preferably 0.4-0.6 wt. %;
Ta: 2.2-4.0 wt. % and preferably 2.6-3.6 wt. %;
Ti: 0.5-0.9 wt. % and preferably 0.6-0.8 wt. %;
W: 5.3-9.8 wt. % more preferably 6.4-8.6 wt. %; and
Ni: balance.

Example 5 (X6):
Al: 4.6-8.5 wt. % and preferably 5.5-7.5 wt. %;
Co: 7.7-14.3 wt. % and preferably 9.4-12.7 wt. %;
Cr: 4.2-7.8 wt. % and preferably 5.1-6.9 wt. %;
Ta: 2.2-4.0 wt. % and preferably 2.6-3.6 wt. %;
W: 5.6-10.4 wt. % more preferably 6.8-9.2 wt. %; and
Ni: balance

Example 6 (X7):
Al: 4.6-8.5 wt. % and preferably 5.5-7.5 wt. %;
Co: 7.0-13.0 wt. % and preferably 8.5-11.5 wt. %;
Cr: 5.6-10.4 wt. % and preferably 6.8-9.2 wt. %;
Ta: 2.8-5.2 wt. % and preferably 3.4-4.6 wt. %;
W: 4.2-7.8 wt. % more preferably 5.1-6.9 wt. %; and
Ni: balance.

Further, the exemplary compositions in accordance with the instant disclosure, including the above-described experimental alloys X2-X7, were formed by blending elemental powders to achieve the target composition. However, as the experimental alloys are intended for use in additive manufacturing, it may be advantageous to produce the powder feed stock via gas atomization (GA). The gas atomization process is known in the art, as disclosed in U.S. Pat. Nos. 4,988,464 and 4,064,295, Europe Patent No. 0 225 080, and in the article by J. Dunkley, “Metal Powder Atomisation Methods for Modern Manufacturing,” the disclosures of which are expressly incorporated by reference herein in their entireties.

### Thermodynamic Criteria

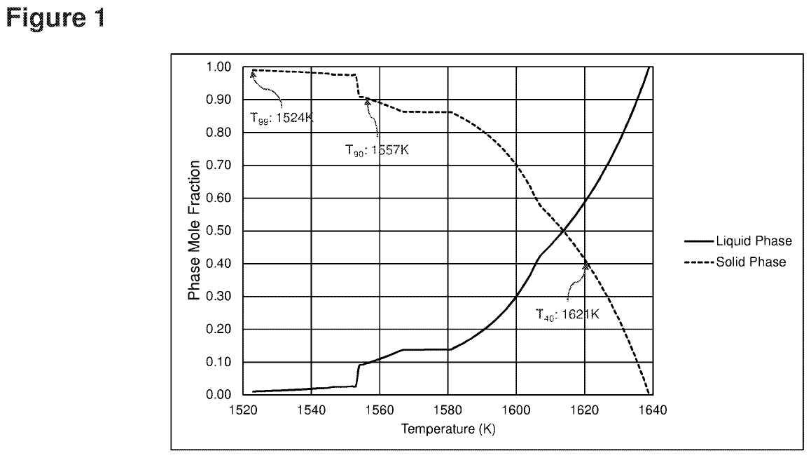

In embodiments, the alloys can be described by the thermodynamic features possessed. The alloys exhibit a low hot cracking index (HCI) defined by Clyne and Davis for predicting hot cracking susceptibility in casting alloys. The hot cracking index is calculated from the Scheil-Gulliver model and is based on the solidification behavior of the alloy. The following equation is used to calculate the hot cracking index criteria:

$$HCI = \frac{{T}_{90} - {T}_{99}}{{T}_{40} - {T}_{90}}$$

Where T₉₉ is the temperature at which 99% solid phase is present, T₉₀ is the temperature at which 90% solid phase is present and T₄₀ is the temperature at which 40% solid phase is present. HCI values can be used to predict an alloy's susceptibility to hot cracking. In embodiments, the HCI value for the alloy is 2.0 or less, preferably, 1.5 or less, and more preferably 0.6 or less. By way of example, FIG. 1 shows the Scheil-Gulliver model for the alloy described in Example 2 (X3), in which the HCI value would be 0.5.

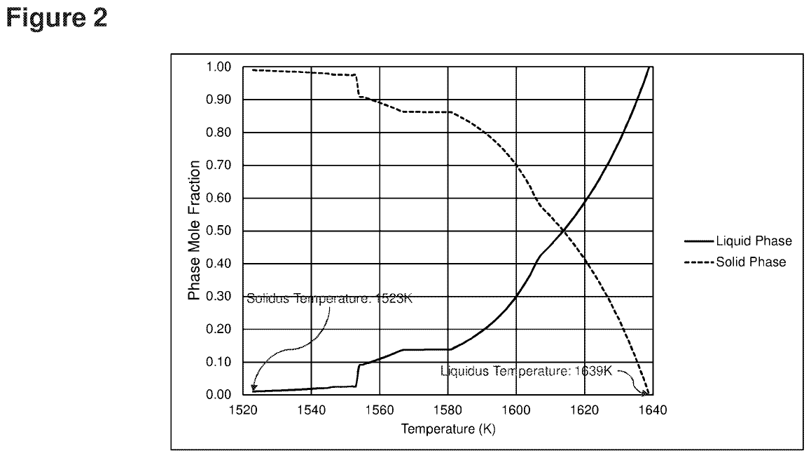

In addition to the HCI, the Scheil-Gulliver model can also be used to calculate an alloy's mushy zone. The mushy zone criteria is defined as the temperature difference between the liquidus and solidus temperatures. The liquidus temperature is defined as the temperature at which the first solid phase begins to form and the solidus temperature is defined as the temperature at which the alloy has completely solidified. Like the HCI, lower mushy zone values can be an indicator of an alloy's tendency for hot cracking or solidifications cracking. Additionally, a low mushy zone is desirable to promote fast solidification of the alloy to reduce compositional inhomogeneities. In embodiments, the mushy zone is 250K or less, preferably 200K or less, and more preferably 150K or less. By way of example, FIG. 2 shows the Scheil-Gulliver model for the alloy described in Example 2 (X3), in which the mushy zone would be 116K.

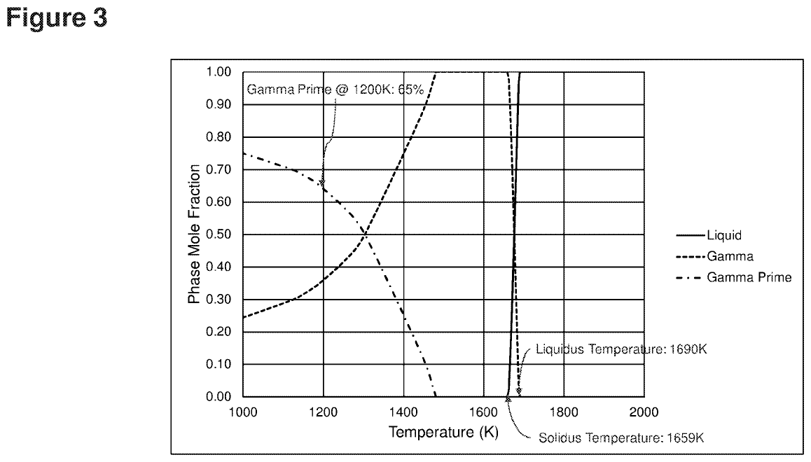

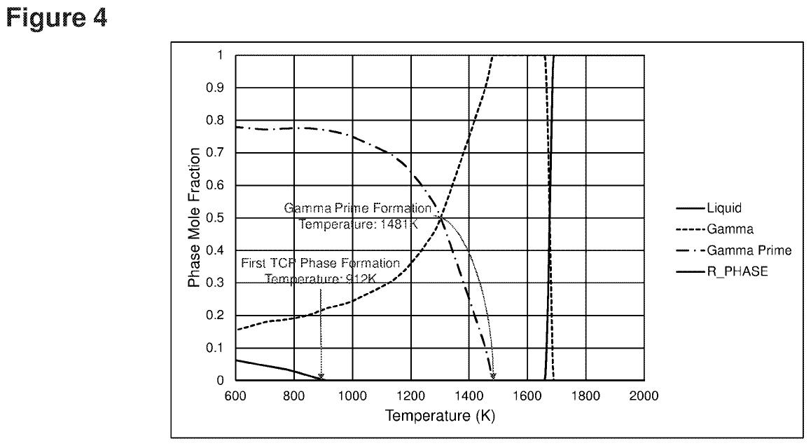

A similar approach to calculating the mushy zone criteria can be applied to equilibrium calculations. By way of non-limiting example, FIGS. 3 and 4 and Table 1 show an equilibrium calculation for example 5 (X6). When using the equilibrium calculations, the same definitions apply to the solidus and liquidus temperatures as discussed above with regard to the Schiel-Gulliver model, and lower mushy zone values, which are referred to as Equilibrium mushy zone values, correspond to alloys with lower susceptibility to hot cracking or solidification cracking. In some embodiments the mushy zone is 100K or less. In preferred embodiments the mushy zone is 75K or less. In still preferred embodiments the mushy zone is 50K or less.

Equilibrium calculations can also be used to predict the gamma prime phase fraction within the alloy. In general, high gamma prime fractions, e.g., greater than 30 mol % at 1200K, are desirable in nickel-based superalloys intended for use in high temperature and high stress applications. Conventionally, cast superalloys used in these types of applications tend to contain gamma prime fractions greater than 50%. High temperature aging heat treatments in the range of about 800-1000° C. (1073-1273K) are commonly used to precipitate the gamma prime phase. However, these conventional cast superalloys cannot be printed crack-free via AM. From equilibrium calculations, the gamma prime phase fraction is taken at 1200K, see FIG. 3. In some embodiments, the gamma prime fraction at 1200K is between 40 and 50 mol %, preferably between 45 and 55 mol %, and more preferably between 55 and 67 mol %.

The formation temperature of gamma prime is another important criteria for predicting the cracking behavior of nickel-based superalloy processed by AM. During solidification of the melt pool, some gamma prime may form. Reheating of the alloy during the application of subsequent layers can also cause additional gamma prime precipitation. The formation and precipitation of gamma prime during AM processing is more likely to occur in nickel-based superalloys designed to form high fractions of gamma prime. The precipitation of gamma prime reduces the alloy's ductility and cracking can occur as internal stresses increase from the heating and cooling cycles produced with the application of each build layer. This phenomenon is often referred to as strain-age cracking. Equilibrium calculations are used to predict an alloy's susceptibility to strain-age cracking by evaluating the formation temperature of gamma prime, as shown in FIG. 4. Lower gamma prime formation temperatures, e.g., less than 1500K, suggest less gamma prime will form during the printing process and therefore reduce the strain-age cracking tendencies of the alloy. In embodiments, the gamma prime formation temperature may be less than 1500K, preferably, less than 1475K, and more preferably less than 1450K.

Like the formation temperature of gamma prime, the formation temperature of the first topologically close-packed (TCP) phase can also be predicted from equilibrium calculations. In embodiments, the first TCP phase formation temperature may be between 900-1650K, preferably between 1100-1600K, and more preferably between 1300-1600K. TCP phases are known to comprise A15 phases, Laves phases, sigma, mu, M, P, and R phases. FIG. 4 shows the first TCP phase formation temperature for example 5 (X6).

All thermodynamic features of the alloys produced by AM processing of the exemplary embodiments of the alloy powders are set forth above and are described in Table I. It is understood that, regardless of the manner in which the exemplary alloy powders are formed, including via gas atomization, the thermodynamic properties of each of the exemplary powders is the same. However, as discussed below, performance characteristics of the alloy powders may vary depending upon the powder composition and application process parameters.

TABLE I

| | | | Equilibrium Calculations | | | |
|---|---|---|---|---|---|---|
| | Scheil Calculations | | Mushy | Gamma Prime | Gamma Prime Formation | TCP Phase Formation |
| Alloy | HCl | Mushy Zone | Zone | @ 1200 K | Temperature | Temperature |
| CM247LC | 2.74 | 460 K | 136 K | 0.62 | 1538 K | 1163 K |
| Ex. 1 (X2) | 0.58 | 127 K | 44 K | 0.66 | 1407 K | 1589 K |
| Ex. 2 (X3) | 0.50 | 116 K | 43 K | 0.65 | 1493 K | 1609 K |
| Ex. 3 (X4) | 1.76 | 152 K | 31 K | 0.40 | 1435 K | 950 K |
| Ex. 4 (X5) | 1.24 | 162 K | 39 K | 0.52 | 1450 K | 1179 K |
| Ex. 5 (X6) | 0.95 | 118 K | 31 K | 0.65 | 1481 K | 912 K |
| Ex. 6 (X7) | 0.88 | 125 K | 31 K | 0.61 | 1493 K | 1000 K |

CM247LC is a conventional gamma prime superalloy. In Table I above, the CM247LC alloy has a nominal composition of: Ni - bal., Al - 5.5 wt. %, C - 0.06 wt. %, Co - 9.2 wt. %, Cr - 8.2 wt. %, Hf - 1.5 wt. %, Mo - 0.5 wt. %, Ta - 3.1 wt. %, Ti - 0.7 wt. %, W - 9.5 wt. %.

### Microstructure Criteria

The embodiments can be described by the microstructural features possessed. In embodiments, the gamma prime phase fraction contained in the microstructure may be greater than 40%, preferably greater than 50%, and more preferably greater than 60%. In embodiments the TCP phase fraction contained in the microstructure is less than 35%, preferably less than 25%, and more preferably less than 15%. In embodiments the crack density contained in the microstructure when processed by AM is less than 1.50 mm/mm², preferably less than 1.00 mm/mm², and more preferably less than 0.50 mm/mm².

### Performance Criteria

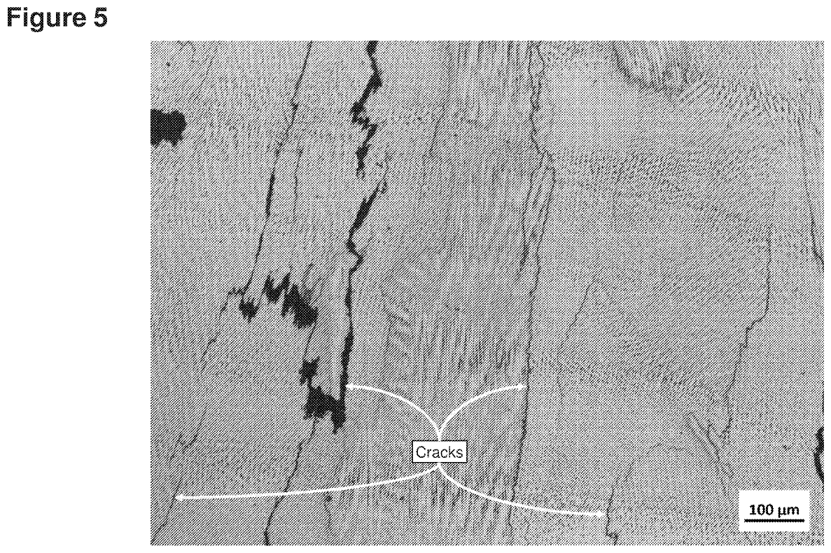

Embodiments are directed to alloys with increased crack resistance as compared to conventionally cast alloys when processed by AM. To take full advantage of the benefits of AM, it is important to produce components free of defects which will result in a significant loss of mechanical properties and functionality of the component. Simple optical microstructure evaluation of a printed component can be used to quantify defects. An example of cracking in a printed microstructure of a conventional nickel-based alloy, such as CM247LC, is shown in FIG. 5. An alloy's susceptibility to cracking during AM processing can be quantified by crack density, which can be calculated by two different methods: 1) a total number of cracks present in a given cross sectional area, in units of cracks per mm² and 2) a sum of lengths of all cracks present in a given cross sectional area, in units of total crack length (mm) per mm². Measuring the crack length per area (method 2) is the more common way of measuring crack density in AM components. Nickel-based alloys designed for conventional casting, like CM247LC, when processed with AM exhibit high crack densities, e.g., 4.96 mm/mm². In contrast, the crack density of the as-printed alloys according to the disclosed embodiments can be less than 1.50 mm/mm², preferably less than 1.00 mm/mm², and more preferably less than 0.50 mm/mm².

In addition to conventional alloy CM247LC, the experimental alloys described above, i.e., X2-X7, were printed using a powder-fed direct energy deposition (DED) machine equipped with a 650 W AO-650 blue (450 nm) laser. The parameters used to print each sample are shown in Table II. Moreover, as noted above, any of the powder compositions of experimental alloys X2-X7 can be formed by gas atomization. By way of example, gas atomized X3 alloy powder was printed using the above-noted powder-fed DED machine and, except for using laser powers 230 W, 240 W, 245 W, 250 W, 260 W and 270 W, the same print parameters were used, as shown in Table II. The printed samples were cross-sectioned and crack density and hardness of each printed sample was measured. Crack density measurement and hardness results are shown in Table III.

TABLE II

| Laser | Ar | Powder | | | |
|---|---|---|---|---|---|
| Power | Flow | Feed Rate | Scan | Perimeter | Infill |
| (W) | (l/min) | (g/min) | Overlap | Speed | (mm/min) |
| 250 | 10 | 1.1 | 50% | 50% | 1000 |
| 230 | 10 | 1.1 | 50% | 50% | 1000 |
| 240 | 10 | 1.1 | 50% | 50% | 1000 |
| 245 | 10 | 1.1 | 50% | 50% | 1000 |
| 260 | 10 | 1.1 | 50% | 50% | 1000 |
| 270 | 10 | 1.1 | 50% | 50% | 1000 |

TABLE III

| | Crack Density | Crack Density | Hardness |
|---|---|---|---|
| Alloy | (cracks/mm²) | (mm/mm²) | (HV_{0.3}) |
| CM247LC | 4.4 | 4.96 | 453 |
| Ex. 1 (X2) | 0.1 | 0.09 | 559 |
| Ex. 2 (X3) | 0.2 | 0.12 | 519 |
| Ex. 3 (X4) | 1.6 | 1.31 | 429 |
| Ex. 4 (X5) | 2.2 | 1.37 | 421 |
| Ex. 5 (X6) | 1.9 | 1.44 | 360 |
| Ex. 6 (X7) | 2.2 | 1.46 | 375 |
| GA X3 230W | 1.3 | 0.82 | 508 |
| GA X3 240W | 1.9 | 1.11 | 494 |
| GA X3 245W | 1.6 | 0.72 | 501 |
| GA X3 250W | 1.4 | 0.74 | 510 |
| GA X3 260W | 1.0 | 0.45 | 515 |
| GA X3 270W | 1.0 | 0.64 | 526 |

Moreover, the sample printed with gas atomized alloy feedstock powder may be improved by including at least one of boron, zirconium or carbon. By way of example, modifying the composition of the gas atomized X3 250 W alloy powder with an addition of 0.1 wt % boron was found reduce crack density to 0.44 mm/mm². Moreover, samples printed with modified compositions of gas atomized X3 250 W alloy powder with 0.5 wt %, 1.0 wt %, 1.5 wt %, and 2.0 wt % zirconium were found to further reduce crack density to 0.26 mm/mm², 0.34 mm/mm², 0.14 mm/mm², and 0.03 mm/mm² respectively.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A nickel-based alloy composition for additive manufacturing, comprising:
4-9 wt. % aluminum;
6-15 wt. % cobalt;
4-26 wt. % chromium;
2-5 wt. % tantalum;
3-13 wt. % tungsten; and
balance nickel.

2. The nickel-based alloy composition according to claim 1, further comprising at least one of:
up to 8 wt. % molybdenum;
up to 1 wt. % titanium; and
up to 4 wt. % niobium.

3. The nickel-based alloy composition according to claim 1, wherein the composition of aluminum is 4.5-7.7 wt. %, the composition of cobalt is 7.7-12.9 wt. %, the composition of chromium is 5-23 wt. %, the composition of tantalum is 2.5-4.8 wt. %, and the composition of tungsten is 3.3-11 wt. %.

4. The nickel-based alloy composition according to claim 3, further comprising at least one of:
up to 7.0 wt. % molybdenum;
up to 0.9 wt. % titanium; and
up to 2.8 wt. % niobium.

5. An additive manufacturing component comprising the nickel-based alloy composition according to claim 1, wherein the component comprises at least one of:
a hot cracking index less than 2.0;
a Scheil mushy zone of less than 250K;
an equilibrium mushy zone less than 100K;
a gamma prime phase fraction at 1200K between 40 and 67 mol %;
a gamma prime formation temperature less than 1500K;
a topologically close-packed (TCP) formation temperature is between 900K and 1650K;
a crack density of less than 1.50 mm/mm²; or
a hardness between 350 HV_{0.3} and 560 HV_{0.3}.

6. The nickel-based alloy composition according to claim 1, wherein the composition comprises:
Al: 3.9-7.2 wt. %;
Co: 6.4-12.0 wt. %;
Cr: 14.0-26.0 wt. %;
Mo: 0.4-0.7 wt. %;
Ta: 2.2-4.0 wt. %;
Ti: 0.5-0.9 wt. %;
W: 6.7-12.4 wt. %; and
Ni: balance.

7. The nickel based alloy composition according to claim 5, wherein the composition of aluminum is 4.7-6.3 wt. %; the composition of cobalt is 7.8-10.6 wt. %; the composition of chromium is 17.0-23.0 wt. %; the composition of molybdenum is 0.4-0.6 wt. %; the composition of tantalum is 2.6-3.6 wt. %; the composition of titanium is 0.6-0.8 wt. %; and the composition of tungsten is 8.1-10.9 wt. %.

8. The nickel-based alloy composition according to claim 1, wherein the composition comprises:
Al: 3.9-7.2 wt. %;
Co: 6.4-12.0 wt. %;
Cr: 5.7-10.7 wt. %;
Mo: 4.2-7.8 wt. %;
Ta: 2.2-4.0 wt. %;
Ti: 0.5-0.9 wt. %;
W: 6.7-12.4 wt. %; and
Ni: balance.

9. The nickel based alloy composition according to claim 9, wherein the composition of aluminum is 4.7-6.3 wt. %; the composition of cobalt is 7.8-10.6 wt. %; the composition of chromium is 7.0-9.4 wt. %; the composition of molybdenum is 5.1-6.9 wt. %; the composition of tantalum is 2.6-3.6 wt. %; the composition of titanium is 0.6-0.8 wt. %; and the composition of tungsten is 8.1-10.9 wt. %.

10. The nickel based alloy composition according to claim 9, further comprising at least one of:
up to 0.2 wt % carbon;
up to 0.2 wt % boron; or
up to 3 wt % zirconium.

11. The nickel-based alloy composition according to claim 1, wherein the composition comprises:
Al: 3.9-7.2 wt. %;
Co: 6.4-12.0 wt. %;
Cr: 5.7-10.7 wt. %;
Mo: 0.4-0.7 wt. %;
Nb: 1.5-2.9 wt. %;
Ta: 2.2-4.0 wt. %;
W: 2.8-5.2 wt. %; and
Ni: balance.

12. The nickel-based alloy composition according to claim 13, wherein the composition of aluminum is 4.7-6.3 wt. %; the composition of cobalt is 7.8-10.6 wt. %; the composition of chromium is 7.0-9.4 wt. %; the composition of molybdenum is 0.4-0.6 wt. %; the composition of niobium is 1.9-2.5 wt. %, the composition of tantalum is 2.6-3.6 wt. %; the composition of tungsten is 3.4-4.6 wt. %.

13. The nickel-based alloy composition according to claim 1, wherein the composition comprises:
Al: 3.9-7.2 wt. %;
Co: 6.4-12.0 wt. %;
Cr: 7.1-13.3 wt. %;
Mo: 0.4-0.7 wt. %;
Ta: 2.2-4.0 wt. %;
Ti: 0.5-0.9 wt. %;
W: 5.3-9.8 wt. %; and
Ni: balance.

14. The nickel-based alloy composition according to claim 17, wherein the composition of aluminum is 4.7-6.3 wt. %; the composition of cobalt is 7.8-10.6 wt. %; the composition of chromium is 8.7-11.7 wt. %; the composition of molybdenum is 0.4-0.6 wt. %; the composition of tantalum is 2.6-3.6 wt. %; the composition of titanium is 0.6-0.8 wt. %; and the composition of tungsten is 6.4-8.6 wt. %.

15. The nickel-based alloy composition according to claim 1, wherein the composition comprises:
Al: 4.6-8.5 wt. %;
Co: 7.7-14.3 wt. %;
Cr: 4.2-7.8 wt. %;
Ta: 2.2-4.0 wt. %;
W: 5.6-10.4 wt. %; and
Ni: balance.

16. The nickel-based alloy composition according to claim 15, wherein the composition of aluminum is 5.5-7.5 wt. %; the composition of cobalt is 9.4-12.7 wt. %; the composition of chromium is 5.1-6.9 wt. %; the composition of tantalum is 2.6-3.6 wt. %; the composition of tungsten is 6.8-9.2 wt. %.

17. The nickel-based alloy composition according to claim 1, wherein the composition comprises:
Al: 4.6-8.5 wt. %;
Co: 7.0-13.0 wt. %;
Cr: 5.6-10.4 wt. %;
Ta: 2.8-5.2 wt. %;
W: 4.2-7.8 wt. %; and
Ni: balance.

18. The nickel-based alloy composition according to claim 17, wherein the composition of aluminum is 5.5-7.5 wt. %; the composition of cobalt is 8.5-11.5 wt. %; the composition of chromium is 6.8-9.2 wt. %; the composition of tantalum is 3.4-4.6 wt. %; and the composition of tungsten is 5.1-6.9 wt. %.

19. An additive manufacturing component comprising:
a nickel-based alloy composition; and
having a hot cracking index of less than 2.0, a Scheil mushy zone of less than 250K, an Equilibrium mushy zone less than 100K, a gamma prime phase fraction at 1200K between 40 and 65 mol %, a gamma prime formation temperature less than 1500K, and a TCP formation temperature between 900K and 1600K.

20. An additive manufacturing component comprising:
a nickel-based alloy composition; and
having a crack density of less than 1.50 mm/mm² and a hardness between 350 HV_{0.3} and 560 HV_{0.3}.
